(19) United States
(12) Patent Application Publication
(10) Pub. No.: US 2002/0171929 A1
(43) Pub. Date: Nov. 21, 2002

(54) Methods for manufacturing display device lenses

(75) Inventors: Deok-Joo Kim, Taejon (KR); Jeong-Su Yu, Taejon (KR); Young-Ki Park, Taejon (KR)

Correspondence Address: Gunnar G. Leinberg, Esq., NIXON PEABODY LLP, Clinton Square, P.O. Box 31051, Rochester, NY, 14603-1051, US

(73) Assignee: LG Chemical Ltd

(21) Appl. No.: 10/137,956

(22) Filed: May 2, 2002

Related U.S. Application Data
(62) Division of application No. 09/446,812, filed on Dec. 23, 1999.
Application No. 09/446,812 is a 371 of international application No. PCT/KR98/00188, filed on Jun. 30, 1998.

(30) Foreign Application Priority Data
Jun. 30, 1997 (KR) 97-29299

(51) Int. Cl. G03B 21/60

(52) U.S. Cl. 359/457

(57) ABSTRACT

Methods of manufacturing lenses used in projection television display device screens. A method includes pressing at least one resin bearing surface of a film over a die mold pattern formed in an outer surface of one or more lens shaping rollers, and curing the resin bearing surfaces to form patterns on the surfaces of the film. The lens shaping rollers are made by forming a patterned planar surface into a cylinder that has a first set of patterns formed in an interior portion of the cylinder, inserting a die mold in the interior portion of the cylinder over the first set of patterns to form a second set of patterns, and separating the die mold from the cylinder to expose the second set of patterns in an outer portion of the die mold. The manufacturing methods produce strong and lightweight screens that are safe and easy to handle.

This application was filed as a Divisional under 37 C.F.R. § 1.53(b), claiming § 120 benefit to U.S. application Ser. No. 09/446,812, which was filed on Jun. 30, 1998 under 37 C.F.R. § 371, the disclosure of which is hereby incorporated by reference in its entirety.

### FIELD OF THE INVENTION

The present invention relates generally to the lenses used in projection televisions and, more particularly, to methods of manufacturing the lenses using one or more patterned lens shaping rollers.

### BACKGROUND OF THE INVENTION

A projection television viewing screen (“projection television screen”) is usually wider than a conventional television viewing screen, and thus weighs much more than the conventional television viewing screen. A projection television screen should be mechanically strong but not too heavy. Since a projection television screen is an exposed component of a projection television, it is vulnerable to impact damage when the television is handled, used or moved. A conventional projection television screen is made from an extruded polymethylmetacrylate (“PMMA”) sheet, which may be either a plain sheet or a sheet with shapes formed upon it to facilitate its various functions. PMMA sheets are heavy, have low mechanical strength and have an especially low impact strength. When a conventional projection television screen is broken by an external impact, the pieces are often very dangerous because they have many sharp edges. Moreover, in the past these screens have been manufactured in a non-continuous way because only a planar shaped die has been available.

### SUMMARY OF THE INVENTION

A method of making lenses in accordance with one embodiment of the present invention includes pressing a resin bearing surface of a film over a die mold pattern formed on a first outer surface of a lens shaping roller, and curing the resin bearing surface to form one or more sets of patterns on a first side of the film.

A method of making a lens shaping roller in accordance with another embodiment of the present invention includes forming a patterned planar surface into a cylinder where the cylinder has a first set of one or more patterns in its interior portion, inserting a die mold in the interior portion of the cylinder and over the first set of one or more patterns to form a second set of one or more patterns, and separating the die mold from the cylinder to expose the second set of one or more patterns in an outer portion of the die mold.

A method of making a lens shaping roller in accordance with yet another embodiment of the present invention includes patterning a flat plate die into a silicone rubber mold die, forming the patterned silicone rubber mold die into a cylindrical die using a reinforcing tube, fabricating a metal die at an interior portion of the cylindrical die, removing the silicone rubber mold die and the reinforcing tube, and manufacturing a forming roll by inserting and fixing a shaft into the metal die.

The present invention provides methods for manufacturing lenses used in projection television screens that are safe, light and mechanically strong. Another advantage of the present invention is a continuous-mode process for increasing the throughput of lens production. Yet another advantage includes enabling roll-shaped dies to be easily fabricated to enable the continuous manufacture of the lenses used in projection television screens.

### BRIEF DESCRIPTION OF DRAWINGS

FIG. 1 illustrates a projection television screen;

FIG. 2 illustrates the components of a projection television screen in accordance with an embodiment of the present invention;

FIG. 3 illustrates a more detailed diagram of the components of the projection television screen in FIG. 2;

FIG. 4 illustrates a process for manufacturing a projection television screen in accordance with another embodiment of the present invention;

FIG. 5 illustrates a conventional process for manufacturing an objective lens;

FIG. 6 illustrates a conventional process for manufacturing a Fresnel lens;

FIG. 7 illustrates another conventional process for manufacturing a Fresnel lens; and

FIG. 8 illustrates a process for fabricating an electroforming roll in accordance with yet another embodiment of the present invention.

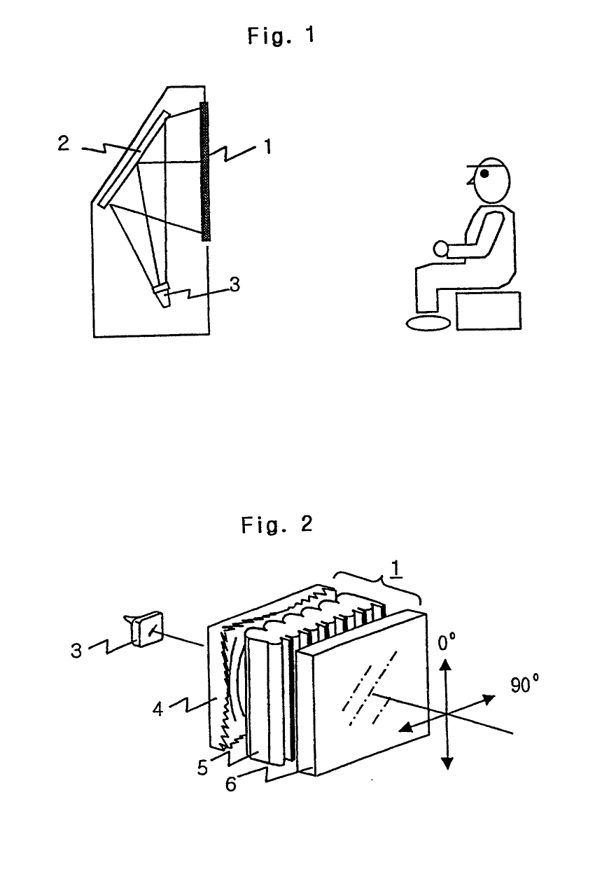

### DETAILED DESCRIPTION OF THE INVENTION

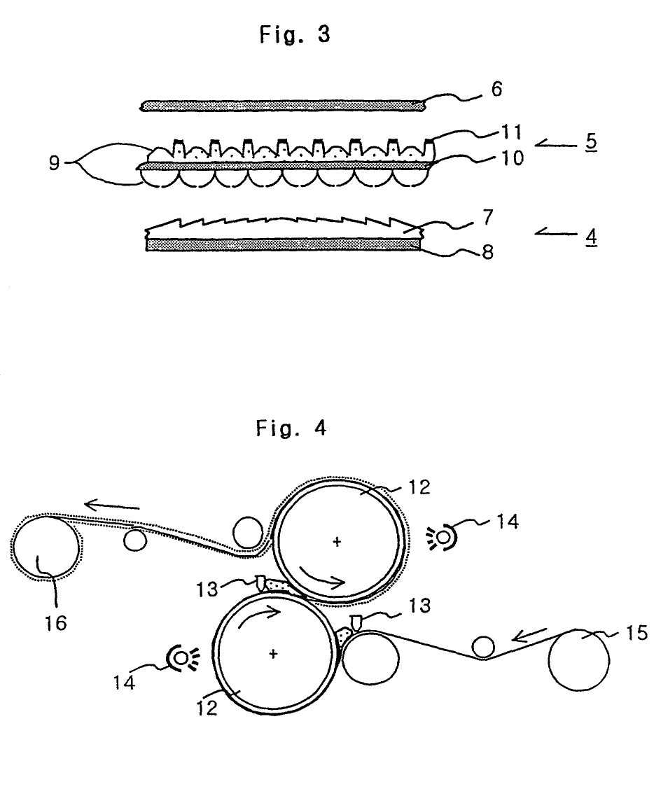

A projection television screen 1 in accordance with an embodiment of the present invention is shown in FIGS. 2 and 3. The screen 1 includes a Fresnel lens 4, an objective lens 5 adjacent to and optically aligned with the Fresnel lens 4, and a transparent protective sheet 6 adjacent to the surface of the objective lens 5 furthest from the Fresnel lens 4. The present invention provides methods for manufacturing lenses used in projection television screens that are safe, light and mechanically strong. Another advantage of the present invention is a continuous-mode process for increasing the throughput of lens production. Yet another advantage includes enabling roll-shaped dies to be easily fabricated to enable the continuous manufacture of the lenses used in projection television screens.

The Fresnel lens 4 includes a first transparent substrate 8, and a phase grating 7 mounted on the surface of the first substrate 8 nearest the objective lens 5. The Fresnel lens 4 collimates light from an image protector 3 and uniformly projects the collimated light onto the surface of the objective lens 5 nearest the Fresnel lens 4. The phase grating 7 is formed from a resin that is cured by exposure to ultraviolet light (“ultra-violet resin”) after the shape of the grating has been impressed upon the fluid resin.

The objective lens 5 includes a second transparent substrate 10, a plurality of lenticular structures 9 mounted on both surfaces of the second substrate 10, and an anti-reflective layer 11 mounted on the surface of the second substrate 10 furthest from the Fresnel lens 4. The objective lens 5 collects parallel red, green, and blue image beams from the Fresnel lens 4 at a predetermined position of each of the color cell. The anti-reflective layer 11 absorbs stray ambient light and thus brightens the images on the screen.

The ultra-violet resin used to make the grating 7 may also be employed to make the lenticular structures 9. The type of film used for the substrate 8 of the Fresnel lens may also be employed for the substrate 10 of the objective lens. A diffusion agent may be used, depending on the degree of light diffusion required, the ultra-violet resin used to make the grating 7. An ultra-violet curing black ink with extinction and adhesion characteristics is employed, for the anti-reflective layer 11.

The protective sheet 6 protects the Fresnel and objective lenses against damage from outside. The material of the protective sheet 6 may be the same as that of the substrate 8 of the Fresnel lens or the substrate 10 of the objective lens. If desired, various coatings such as an anti-reflection coating and a scratch-resistant coating may be applied to the protective sheet 6. The protective sheet may also be colored.

The viscosity of the ultra-violet resin used to make the grating 7 and the lenticular structures 9 ranges from 100 to 3000 cps at 25° C. The resin transmits more than 75% of the light incident on it. Preferably, the viscosity of the ultra-violet resin lies within the range 500 to 1500 cps at 25° C., and the transmissivity of the resin is more than 85%. Although the resin could be sufficiently spread on the surface of a shaping roller 12, when the viscosity is less than 100 cps, process control would not be easy and a significant amount of low-boiling point material would be lost. If the resin's viscosity were more than 3000 cps, spray coating process would be difficult and air bubbles could well be formed because the shaping roller 12 would not be sufficiently wet by the resin.

Materials that may be used for the ultra-violet resin of the grating 7 and the lenticular structures 9 include urethane acrylate resin, epoxy acrylate resin, ester acrylate resin, ether acrylate resin and mixtures thereof.

The transparent substrate 8 of the Fresnel lens 4, the transparent substrate of the objective lens 5, and the protective sheet 6 preferably have thickness of 10-250 μm, light transmissivity of 75% or more and a tensile strength of at least 600 kg/cm² and more preferably thickness of 50-150 μm, light transmissivity of 85% or more and a tensile strength of at least 1000 kg/cd. If the thickness were less than 10 gm or the tensile strength less than 600 kg/cm², the screen 1 could be easily damaged and the film torn during the preparation of the screen. If the thickness were more than 250 μm, the total thickness and weight of the screen 1 would be too great and the advantages of employing a film in the present invention would be lost. If the transmissivity were less than 75%, the transmissivity the screen 1 would be too low.

Materials which may be used for the transparent film of the substrate 8 of the Fresnel lens, the substrate 10 of the objective lens, and the protective sheet 6 include: polyester, polyestersulfon, polyamide 6, polyamide 66, polycarbonate, polyestersulfon, polyester ketone, polyesterimide, polyacrylate, and mixtures thereof.

FIG. 4 illustrates an apparatus for making shapes on one surface or both surfaces of the substrate of the Fresnel lens 4 and the objective lens 5 according to the present invention, the apparatus comprising a shaping roller 12; a device 13 for applying liquid resin to the substrate; an ultra-violet irradiating device 14; and a roller 15 for supplying the substrate film. The shaping roller 12 is easily replaceable in order to impress one surface or both surfaces of the substrate with various shapes.

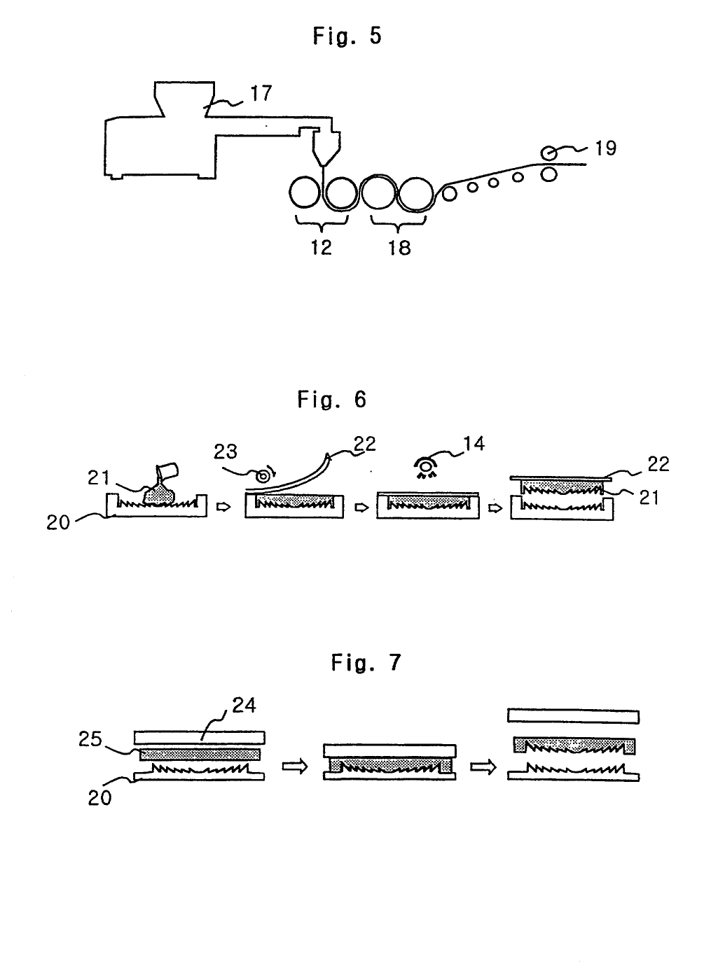

FIG. 5 illustrates a conventional apparatus used for manufacturing an objective lens. In FIG. 5, a film extruded by an extruder 17 is shaped by a shaping roller 12 and thereafter cooled by a cooling roller 18 and drawn by a drawing roller 19. Such an apparatus cannot be used for manufacturing a thin-film objective lens.

FIG. 6 illustrates a conventional process of manufacturing a Fresnel lens. In the process shown in FIG. 6, a liquid ultraviolet resin 21 is poured into a flat mold 20 to shape a Fresnel lens. The flat mold 20 is then covered with a panel 22 which forms the substrate of the Fresnel lens. The resin 21 is passed through a roller 23 and is exposed to an ultra-violet irradiating device 14. The conventional method of FIG. 6 is not applicable to mass production and the process can be operated only in a batch mode. A thin-film type substrate could not easily be used in the method illustrated by FIG. 6.

FIG. 7 illustrates a conventional process of manufacturing a Fresnel lens using a press. In the process shown in FIG. 7, a Fresnel substrate 25 is inserted between the flat mold 20 and a planar upper die 24. The Fresnel substrate 25 is then heated, pressed, rolled and released. However, this press process has the disadvantages of long manufacturing time, and short duration of the die, and consequent low productivity.

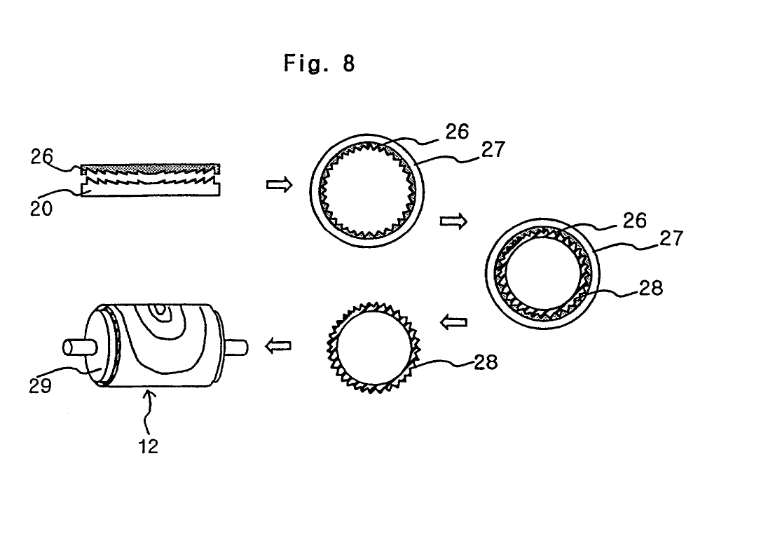

FIG. 8 illustrates a process of manufacturing a shaping roller for forming a Fresnel lens and an objective lens according to an embodiment of the present invention. According to the present invention, the Fresnel lens 4 and the objective lens 5 can be manufactured in continuous mode due to the use of a roll shaped die rather than the planar die of the prior art.

The electroforming method illustrated in FIG. 8 may be used for manufacturing a shaping roller. In FIG. 8, a silicone rubber die mold 26 is patterned using a planar die 20. The patterned silicone rubber die mold 26 is made into a tube-type die by a reinforcing steel tube 27. After a metal electroforming die 28 made of nickel chromium, for example, has been fabricated at the inner side of the tube-type silicone rubber die mold 26 by means of an electroforming method, the reinforcing steel tube 27 is removed, which leaves only the electroformed metal die 28. Finally the shaping roller is completed by inserting and fixing a cylindrical steel tube roller with a shaft into the electroformed metal die 28.

One or more embodiments of the present invention will be more fully understood with reference to the following examples. In the first example, Urethane acrylate resin is used as the ultra-violet resin of the grating 7 and the lenticular structures 9. Polyester film is used for the substrate 8 of the Fresnel lens, the substrate 10 of the objective lens, and the protective sheet 6. The properties of urethane acrylate resin and polyester film used in this example are summarized in tables 1 and 2 below, respectively.

The process conditions are as follows:

surface temperature: 35±° C.; and

manufacturing speed: 4 to 7 m/min.

### Comparative Example

A comparative product is manufactured as a conventional product. Polymethylmetacrylate is used for the substrate 8 of the Fresnel lens and the substrate 10 of the objective lens. Urethane acrylate is used for the grating 7.

TABLE I
Properties of Urethane Acrylate Resin used in Fresnel lens 4 and
lenticular lens:

| Item | Properties | Remarks |
|---|---|---|
| Composition | Urethaneacrylate | Sunkyung-UCB Co., Ltd. |
| Viscosity(cps) | 950 ± 50 | 25° C. |
| Transmission rate of total | 91 ± 1 | |
| amount of light (%) | | |
| Index of Reflection | 1.52 ± 0.02 | |
| Specific Gravity | 1.1 | |

TABLE 2
Properties of Polyester Film used in Productive Sheet:

| Item | Properties | Remarks |
|---|---|---|
| Composition | Polyester | SKC Co., Ltd. |
| Thickness (μm) | 200 | protective sheet |
| | 100 | Fresnel lens |
| | 50 | lenticular lens |
| Index of Reflection | 1.64 ± 0.01 | |
| Transmission rate of total | 91 | |
| amount of light (%) | | |
| Specific Gravity | 1.4 | |
| Tensile Strength | 2,500 ± 50 | |
| (Kg/cm²) | | |

TABLE 3
Properties of the Screens:

| | | | Comparative | |
|---|---|---|---|---|
| Item | | Example 1 | Example 1 | |
| Weight | protective sheet(6) | 160 | 1260 | |
| (gr) | Fresnel lens(4) | 140 | 504 | |
| | objective lens(5) | 191 | 1250 | |
| | Total | 491 | 3014 | |
| Thickness of Screen (mm) | | 0.85 | 5.00 | |
| Tensile | protective sheet(6) | 2500/2500 | 550/550 | *Polyester film |
| Strength | Fresnel lens(4) | 2200/2200 | 480/480 | 0° direction |
| (Kg/cm²) | objective lens(5) | 2100/2050 | 500/120 | (90° direction) |

| | | |
|---|---|---|
| Transmission rate of total amount of | 89 | 85 |
| light (%) | | |

| | |
|---|---|
| Particulars | - Screen (1) diagonal length: 43 inches |
| | - Aspect ratio = 4:3 |

As can be seen from Table 3, the projection television screen 1 according to an embodiment of the present invention weighs about 84% less and has a tensile strength about 4.5 times greater than a conventional television screen.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Further, the recited order of elements, steps or sequences, or the use of numbers, letters, or other designations therefor, is not intended to limit the claimed processes to any order except as may be explicitly specified in the claims. Accordingly, the invention is limited only by the following claims and equivalents thereto.

What is claimed is:

1. A method of making lenses, the method comprising:
pressing a first side of a film over a die mold pattern formed on a first outer surface of a lens shaping roller, the film having a first resin on the first side; and
curing the first resin to form one or more sets of patterns on the first side of the film.

2. The method according to claim 1 further comprising:
pressing a second side of the film over another die mold pattern formed on a second outer surface of another lens shaping roller, the film having a second resin on the second side; and
curing the second resin to form another one or more sets of patterns on the second side of the film.

3. The method according to claim 2 further comprising applying the first resin on the first side and the second resin on the second side of the film.

4. The method according to claim 2 wherein pressing a first side and a second side of a film further comprises using one or more tensioning rollers to apply tension to the film for keeping the film taut.

5. The method according to claim 2 wherein curing the first resin or the second resin further comprises irradiating the first side and the second side of the film with ultra-violet radiation.

6. A method of making a lens shaping roller, the method comprising:
forming a patterned planar surface into a cylinder, a first set of one or more patterns in an interior portion of the cylinder;
inserting a die mold in the interior portion of the cylinder over the first set of one or more patterns to form a second set of one or more patterns; and
separating the die mold from the cylinder to expose the second set of one or more patterns in an outer portion of the die mold.

7. The method according to claim 6 wherein inserting a die mold in the interior portion of the cylinder further comprises fabricating the die mold using an electroforming process.

8. The method according to claim 6 further comprising inserting an elastic material into a planar pattern die to form the patterned planar surface.

9. The method according to claim 6 wherein forming a patterned planar surface into a cylinder further comprises wrapping the patterned planar surface along an inner surface of a hollow tubular object.

10. The method according to claim 9 wherein separating the die mold from the cylinder further comprises removing the hollow tubular object.

11. The method according to claim 6 further comprising inserting a rotation assembly in an interior part of the die mold, the rotation assembly enabling the die mold to be rotated in a lens making system.

12. A method for making a shape forming roller used in manufacturing projection television screens, the method comprising:
patterning a flat plate die into a silicone rubber mold die;
forming the patterned silicone rubber mold die into a cylindrical die using a reinforcing tube;
fabricating a metal die at an interior portion of the cylindrical die;
removing the silicone rubber mold die and the reinforcing tube; and
manufacturing a forming roll by inserting and fixing a shaft into the metal die.

13. The method according to claim 12 wherein fabricating a metal die further comprises electroforming the metal die.
